(19) United States
(12) Patent Application Publication
(10) Pub. No.: US 2015/0347077 A1
(43) Pub. Date: Dec. 3, 2015

(54) DISPLAY DEVICE, MULTI-DISPLAY SYSTEM AND MULTI-DISPLAY METHOD

(71) Applicant: Tohru KATAOKA, Tokyo (JP)

(72) Inventor: Tohru KATAOKA, Tokyo (JP)

(21) Appl. No.: 14/759,688

(22) PCT Filed: Jan. 21, 2013
(86) PCT No.: PCT/JP2013/051075

§ 371 Date: Jul. 8, 2015

(51) Int. Cl. G06F 3/14; G06F 3/147

(52) U.S. Cl. CPC G06F 3/1431; G06F 3/147; G06F 3/1446; G09G 2300/026

(57) ABSTRACT

A display device (and method) includes a receiving unit that receives a video signal output from a superordinate device. A display unit displays at least part of the image according to the video signal. A storage unit-stores the resolution of the image to be displayed on the display unit. A connector can be connected to a subordinate display device. A communication unit, when a subordinate display is connected to the connector, receives a second resolution as the resolution notified by the subordinate display device and outputs the video signal to the subordinate display device. A control unit provides notification to the superordinate device of a third resolution according to the first and second resolutions, the first resolution being a resolution of the display unit and being a resolution of an image to be displayed on the display unit, the resolution of the image being previously stored in the storage unit.

### TECHNICAL FIELD

The present invention relates to a display device, a multi-display system and a multi-display method.

### BACKGROUND ART

Recently, there has been a large increase in the number of multi-display systems that display a single image by using a plurality of display devices. A multi-display system includes a signal source that supplies a video signal and a plurality of display devices that display images in accordance with the video signal output from the signal source, and performs a multi-display in which a single combined image is formed by joining together images that are displayed by each of the individual display devices. Accordingly, in the multi-display system, it is possible to form a large-scale image with a higher resolution than the image displayed by each single display device.

There is a multi-display system in which a plurality of display devices are cascade connected to a signal source (see Patent Document 1). In this case, the signal source outputs a single video signal, and the display device, which receives the video signal output from the signal source, displays part of the image in accordance with the video signal and transmits the video signal to the display device at the second stage. The display device at the second stage displays part of the image in accordance with the video signal and transmits the video signal to the display device further downstream. In this multi-display system, as the number of display devices cascade connected to the signal source increases, it is possible to create a higher resolution image.

In the above multi-display system, it is necessary to output a video signal with a resolution that corresponds to a synthesized image made up of the images that are to be displayed on individual display devices. This resolution of the synthesized image is determined according to the system configuration of the multi-display system, for example, the number and the resolution of display devices included in the multi-display system, so that the signal source needs to output a video signal that has a resolution that conforms to the system configuration.

When a dedicated signal source for multi display is used as the signal source, the dedicated signal source for multi display usually has a function that allows the user to set the resolution of the video signal that is to be output. Accordingly, it is possible to easily output a video signal that has a resolution that conforms to the system configuration.

### RELATED ART DOCUMENTS

Patent Documents

Patent Document 1: JP2004-347667A

### SUMMARY OF THE INVENTION

### Problems to be Solved by the Invention

However, general signal sources such as PCs (Personal Computer) and the like cannot always output video signals of a desired resolution.

Specifically, the general signal source acquires, from the display device that is connected to the general signal source, EDID (Extended Display Identification Data) that indicates the characteristics of the display device, and outputs the video signal that corresponds to the resolution described in this EDID.

Because the system configuration of a multi-display system differs case by case, the resolution described in EDID does not always conform to the current system configuration. Therefore, the general signal source cannot always output video signals with a resolution that conforms to the system configuration.

Accordingly, use of a general signal source entails the problem in which images having a resolution that conforms to the system configuration cannot be displayed.

It is an object of the present invention to provide a display device, a multi-display system and a multi-display method that can display images with a resolution that conforms to a system configuration even when a general signal source is used.

### Means for Solving the Problems

A display device according to the present invention includes:

a receiving unit that receives a video signal output from a superordinate device;

a display unit that displays at least a part of an image according to the video signal;

a storage unit that stores a resolution of the image to be displayed on the display unit;

a connector to which a subordinate display device can be connected;

a communication unit that, when a subordinate display is connected to the connector, receives a second resolution, which is a resolution notified by the subordinate display device, and outputs the video signal to the subordinate display device; and,

a control unit that provides notification to the superordinate device of a third resolution according to a first resolution and the second resolution, wherein the first resolution is a resolution of the display unit and is a resolution of an image that is displayed on the display unit, the resolution of the image being previously stored in the storage unit.

A multi-display system according to the present invention includes:

a signal source that outputs a video signal; and

a plurality of display devices that each displays part of an image according to the video image output from the signal source, wherein

the plural display devices are cascade connected, and

each display device includes:

a receiving unit that receives a video signal output from a superordinate device;

a display unit that displays at least part of the image according to the video signal;

a storage unit that stores a resolution of an image to be displayed on the display unit;

a connector to which a subordinate display device can be connected;

a communication unit that, when a subordinate display is connected to the connector, receives a second resolution, that is a resolution notified by the subordinate display device, and outputs the video signal to the subordinate display device; and,

a control unit that provides notification to the superordinate device of a third resolution according to a first resolution and the second resolution, wherein the first resolution is a resolution of the display unit and is a resolution of an image that is displayed on the display unit, the resolution of the image being previously stored in the storage unit.

A multi-display method according to the present invention, is used in a multi-display system that includes a signal source that outputs a video signal; and a plurality of display devices that each displays part of an image according to the video image output from the signal source, the plural display devices being cascade connected, the multi-display method comprising,

each display device:

detecting that a subordinate display device is connected to the display device;

acquiring, from a storage unit, a first resolution which is a resolution of the display unit and which is a resolution of an image that is displayed on the display unit;

receiving a second resolution which is a resolution notified by the subordinate display device;

providing notification to the superordinate device of a third resolution according to the first and second resolutions;

receiving a video signal according to the third resolution from the superordinate device;

displaying part of the received video signal; and,

outputting the video signal to the subordinate device.

### Effect of the Invention

According to the present invention, it is possible to output a video signal having a resolution that conforms to a system configuration even when a general signal source is used.

### BRIEF DESCRIPTION OF THE DRAWINGS

FIG. 1 A diagram showing a configuration of a multi-display system according to the first exemplary embodiment of the present invention.

FIG. 2 A block diagram showing a configuration of a projector of the multi-display system of FIG. 1.

FIG. 3 A block diagram showing a detailed configuration of an output unit of the projector of FIG. 2.

FIG. 4 A diagram for illustrating processing of a horizontal DE signal in a DE processing unit in FIG. 3.

FIG. 5 A diagram for illustrating processing of a vertical DE signal in a DE processing unit in FIG. 3.

FIG. 6 A sequence diagram for illustrating an operation example of a multi-display system according to the same exemplary embodiment.

FIG. 7 A diagram showing a configuration of a multi-display system according to the second exemplary embodiment of the present invention.

FIG. 8A A sequence diagram for illustrating an operation example of a multi-display system according to the same exemplary embodiment.

FIG. 8B A sequence diagram for illustrating an operation example of a multi-display system according to the same exemplary embodiment.

FIG. 9 A diagram for illustrating processing of a horizontal DE signal in a DE processing unit according to the same exemplary embodiment.

### MODE FOR CARRYING OUT THE INVENTION

Next, the exemplary embodiments of the present invention will be described with reference to the accompanying drawings. In the present description and the drawings, the same components having the same functions are allotted the same reference numerals, so that repeated description may be omitted.

### The First Exemplary Embodiment

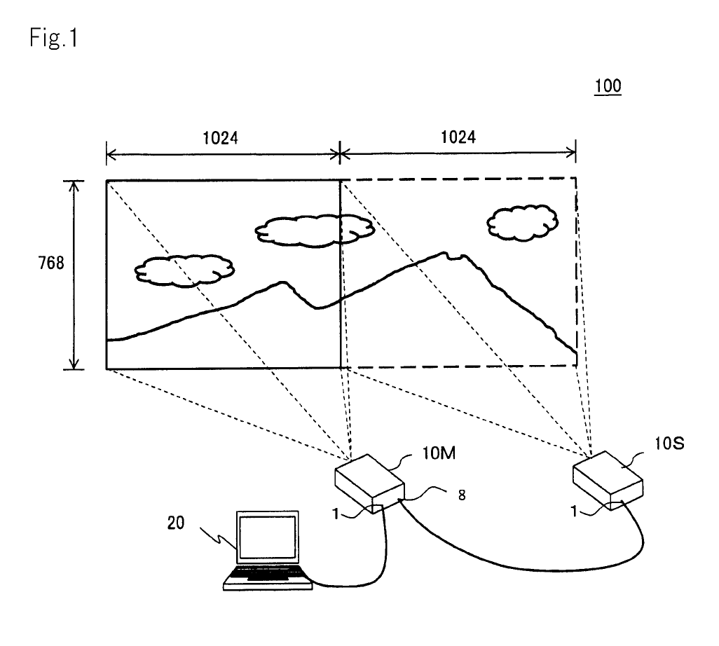

FIG. 1 is a diagram showing a configuration of a multi-display system according to the first exemplary embodiment of the present invention.

Multi-display system 100 shown in FIG. 1 includes two projectors 10 and PC (Personal Computer) 20 as a signal source of video signals. Of the two projectors 10, the projector 10 connected directly to PC 20 and arranged on the left side when viewed toward the images projected by the projectors is called master projector 10M. The projector 10 arranged on the right side when viewed toward the images projected by projectors 10 is called slave projector 10S.

Input terminal 1 of master projector 10M is connected to PC 20 while output terminal 8 of master projector 10M is connected to input terminal 1 of slave projector 105.

Master projector 10M displays the left half of the image based on the video image output by PC 20 and outputs the video signal to slave projector 105. Slave projector 10S displays the right half of the image based on the video image output by PC 20 (Master projector 10M).

It is assumed in this case that master projector 10M and slave projector 10S each display an image having a resolution of 1024×768. Thereby, the multi-display system as a whole displays an image having a resolution of 2048×768.

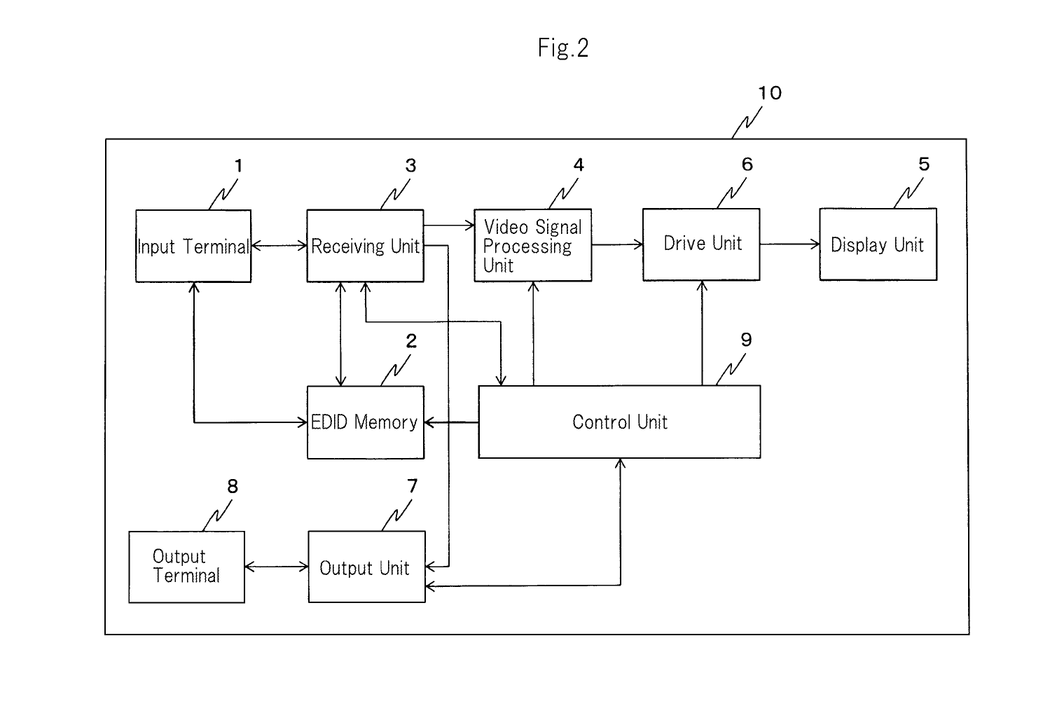

FIG. 2 is a block diagram showing a configuration of projector 10 of multi-display system 100.

Projector 10 shown in FIG. 2 includes input terminal 1, EDID memory 2, receiving unit 3, video signal processing unit 4, display unit 5, drive unit 6, output unit 7, output terminal 8 and control unit 9.

Input terminal 1 is connected to a superordinate device via cable and receives video signals and control signals output from the superordinate device. In the present exemplary embodiment, when projector 10 is master projector 10M, the superordinate device connected to input terminal 1 is PC 20, whereas when projector 10 is slave projector 10S, the superordinate device is master projector 10M. Here, when the superordinate device performs an EDID acquisition process via this input terminal 1, EDID is notified to the superordinate device via input terminal 1.

Input terminal 1 supports the standards such as, for example, HDMI (High-Definition Multimedia Interface), DVI (Digital Visual Interface), and DP (Display Port). In conformity with these standards, video signals, audio signals and control signals are transmitted by way of a single cable. It is assumed in the present exemplary embodiment that input terminal 1 is a terminal that supports the HDMI standard. Input terminal 1 outputs the received video signal and control signal to receiving unit 3.

EDID memory 2 is a storage unit that stores EDID that represents the performance, functions and the like of display unit 5. Since the characteristics of the video signal that display unit 5 supports are different depending on the performance and functions of display unit 5, this means that EDID represents the characteristics of the video signal that display unit 5 supports. EDID includes the resolution of the video signal that display unit 5 supports. The signal source can acquire an EDID to automatically set up the formats of the video and audio that the signal source outputs. The resolution contained in the EDID is the resolution of the video signal when single display unit 5 displays the image based on the video signal. The resolution when each projector 10 alone displays the image based on the video signal in the above way will be called individual resolution in order to distinguish it from the resolution of the combined image of the images that are displayed by a plurality of projectors 10. In the present exemplary embodiment, the resolution in EDID that is stored in EDID memory 2 is renewed to a predetermined resolution so as to change the resolution of the video that a signal source outputs.

Receiving unit 3 is a receiver that supports the standard of input terminal 1, and is an HDMI receiving unit in the present exemplary embodiment. Receiving unit 3 receives video signals and control signals output from input terminal 1 and performs various signal processes for the received signals. The signal processes performed by receiving unit 3 herein may include serial-to-parallel conversion of video signals, signal level conversion, decoding of various timing signals included in control signals. Here, the timing signals may include, for example, a horizontal synchronization signal that represents separations of the video signal in the horizontal direction, a vertical synchronization signal that represents separations of the video signal in the vertical direction, a DE (Data Enable) signal which is a display area information that represents the valid periods in which display is given and the invalid periods in which no display is given in the video signal, a dot clock that indicates the reciprocal of the time required for displaying a single dot, and the like. Receiving unit 3 outputs the video signal after conversion and the control signal that includes various timing signals after decoding to video signal processing unit 4 and output unit 7.

Video signal processing unit 4 receives the video signal and control signal output by receiving unit 3, and performs a video signal process based on the received video signal. The video signal process performed by video signal processing unit 4 may include, for example, a 7-correcting process, a distortion correcting process and the like. Video signal processing unit 4 outputs a video signal with which the video signal process is performed and the control signal to drive unit 6.

Display unit 5 displays the image in accordance with the supplied input video signal. Display unit 5 includes, for example, a light source that emits light, a display element that outputs light of the image by modulating the light from the light source in accordance with the input video signal, and a projection optical system that projects the light of the image output by the display element. Display unit 5 is driven by drive unit 6 and the image based on the video signal is displayed by projecting light emitted from the light source.

Drive unit 6 drives display unit 5. For example, drive unit 6 drives the display element, the light source and the like of display unit 5 to thereby cause display unit 5 to emit the image light. At this time, drive unit 6, in accordance with the DE signal included in the received control signal, supplies the video signal to the display element to cause display unit 5 to display at least part of the image according to the video signal during the valid period. For example, when the horizontal resolution of the image according to the input video signal is higher than the resolution of display unit 5, drive unit 6 causes display unit 5 to display the partial image from the lead of the image according to the video signal to the position that corresponds to the horizontal resolution of the display unit 5.

Output unit 7 performs various kinds of signal processes on the video signal and control signal output from receiving unit 2 and outputs the signal-processed video signal and control signal.

Output terminal 8 is a connector that can be connected via HDMI cable to another projector 10 as a subordinate display device. Output terminal 8 is a terminal that conforms to the HDMI standard in this exemplary embodiment.

Control unit 9 is a control device such as, for example, CPU (Central Processing Unit) or the like, and controls receiving unit 3, video signal processing unit 4, drive unit 6, output unit 7 and the like.

When there is a second projector 10 connected to output terminal 8, control unit 9 regards the second projector 10 as slave projector 105, acquires the EDID of slave projector 10S via output unit 7 and output terminal 8, and sets the resolution described in the acquired EDID to be the second resolution.

Control unit 9 provides notification to the superordinate device of the third resolution according to the first and second resolutions, the first resolution being the resolution described in the EDID stored in EDID memory 2, the second resolution being the resolution notified by the subordinate device. At this time, control 9 notifies the third resolution to the superordinate device when the first resolution and the second resolution are same.

Concretely, control unit 9 calculates, based on the first resolution and the second resolution, the resolution of the synthesized image of the image displayed by display unit 5 and the image displayed by slave projector 10S, and sets the calculated result as the third resolution that is to be notified to the superordinate device. Control unit 9 notifies the third resolution to the superordinate device, which is PC 20, by replacing the resolution in the EDID stored in EDID memory 2 with the third resolution.

Here, when, for example, control unit 9 has detected a signal that indicates that the power of projector 10 has been turned off, or has detected a signal that indicates cancellation of multi-display system 100, control unit 9 may rewrite the EDID stored in the updated EDID memory 2 to the initial EDID. For example, when control unit 9 has detected the signal that indicates that the power of projector 10 has been turned off, control unit 9 may rewrite the third resolution stored in the updated EDID memory 2 with the first resolution.

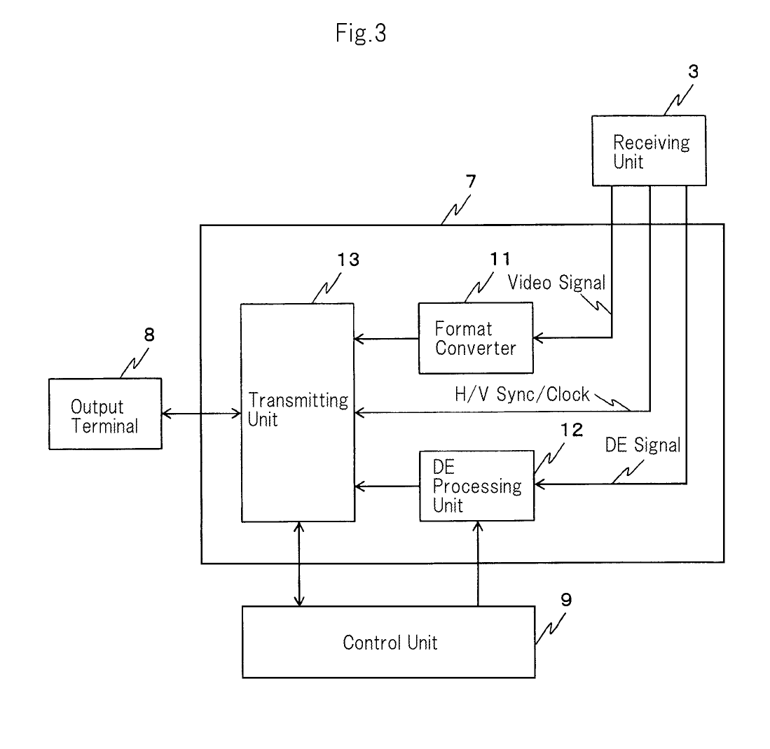

FIG. 3 shows a block diagram showing a detailed configuration of output unit 7 of projector 10.

Output unit 7 is a communication unit which, when a subordinate display device is connected to output terminal 8, receives the second resolution that is the resolution notified from the subordinate display device and outputs the video signal to the subordinate display device. Output unit 7 includes an aftermentioned format converter 11, DE processing unit 12 and transmitting unit 13

Format converter 11 receives the video signal output from receiving unit 3 and converts the format of the video signal into a format that conforms to the selected standard. Format converter 11 outputs the format-converted video signal to transmitting unit 13.

DE processing unit 12 receives the control signal output from receiving unit 3 and processes the ED signal included in the received control signal into information that corresponds to the section that is displayed by projector 10S which is the subordinate display device connected to output terminal 8 of projector 10. DE processing unit 12 outputs the control signal that includes the processed DE signal to transmitting unit 13.

Herein, DE signal processing process by DE processing unit 12 will be described more specifically. There are two kinds of DE signals, namely, the horizontal DE signal and the vertical DE signal. The horizontal DE signal indicates the valid period of the video signal in the horizontal direction. The vertical DE signal shows the valid period of the video signal on the vertical direction.

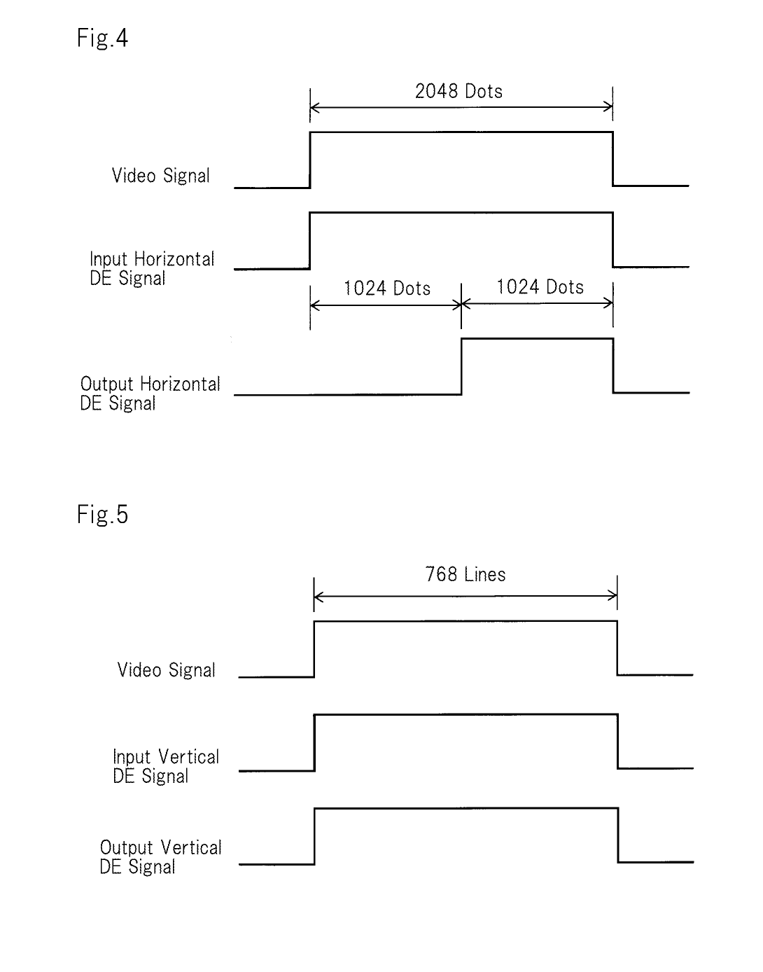

FIG. 4 is a diagram for illustrating processing of the horizontal DE signal. In the exemplary embodiment, the video signal having a resolution of 2048×768 is input while the input horizontal DE signal input to DE processing unit 12 of master projector 10M indicates that the entire period provided by 2048 dots of the video signal in the horizontal direction is the valid period. DE processing unit 12 processes the input horizontal DE signal so that the section, that corresponds to the left side 1024 dots in the image based on the video signal and which is the part to be displayed by master projector 10M, is set to an invalid period (so that the section, that corresponds to the right side 1024 dots in the image based on the video signal and which is the part to be displayed by slave projector 10S, is set to a valid period). The horizontal DE signal after processing is shown in the bottom in FIG. 4.

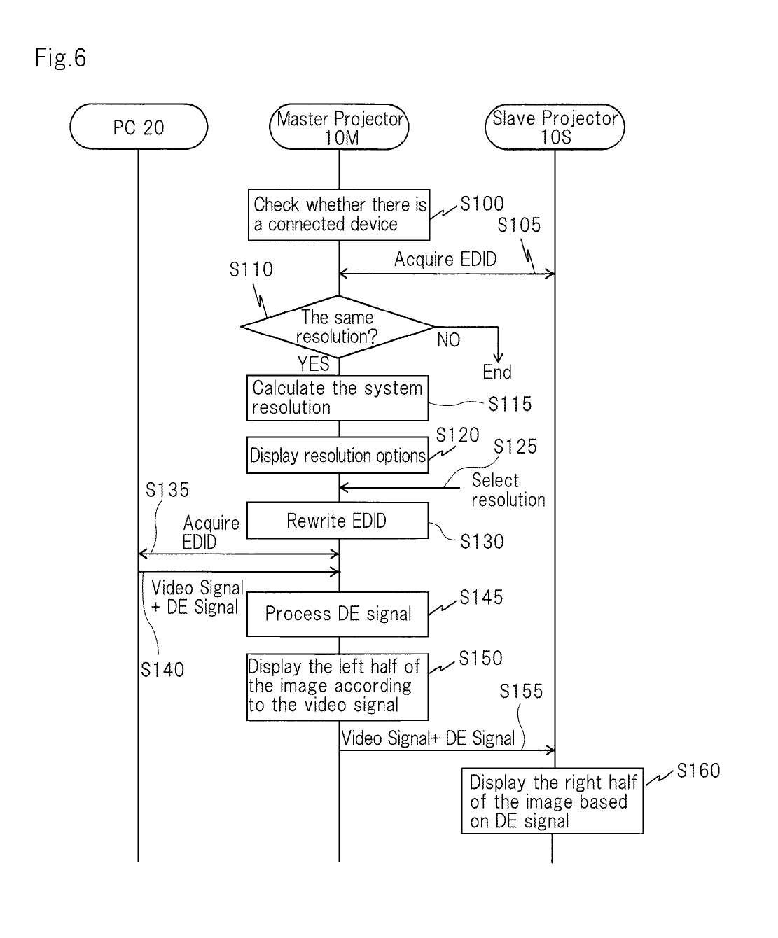

FIG. 5 is a diagram for illustrating processing of the vertical DE signal. In the present exemplary embodiment, slave projector 10S is connected to master projector 10M only in the horizontal direction while these projectors are not connected in the vertical direction. Accordingly, DE processing unit 12 will not perform any processing of the vertical DE signal because each projector 10 displays all sections of the video signal in the vertical direction. The input vertical DE signal supplied to DE processing unit 12 and the output vertical DE signal output from DE processing unit 12 each indicate that the entire period of the video signal of 768 lines is a valid period.

Returning to explanation with FIG. 3, transmitting unit 13 outputs the video signal, that is output from format converter 11, and the control signal to the downstream slave projector 10S connected to output terminal 8. At this time, the control signal includes the DE signal that is output from DE processing unit 12, the horizontal synchronization signal, the vertical synchronization signal, dot clocks and the like.

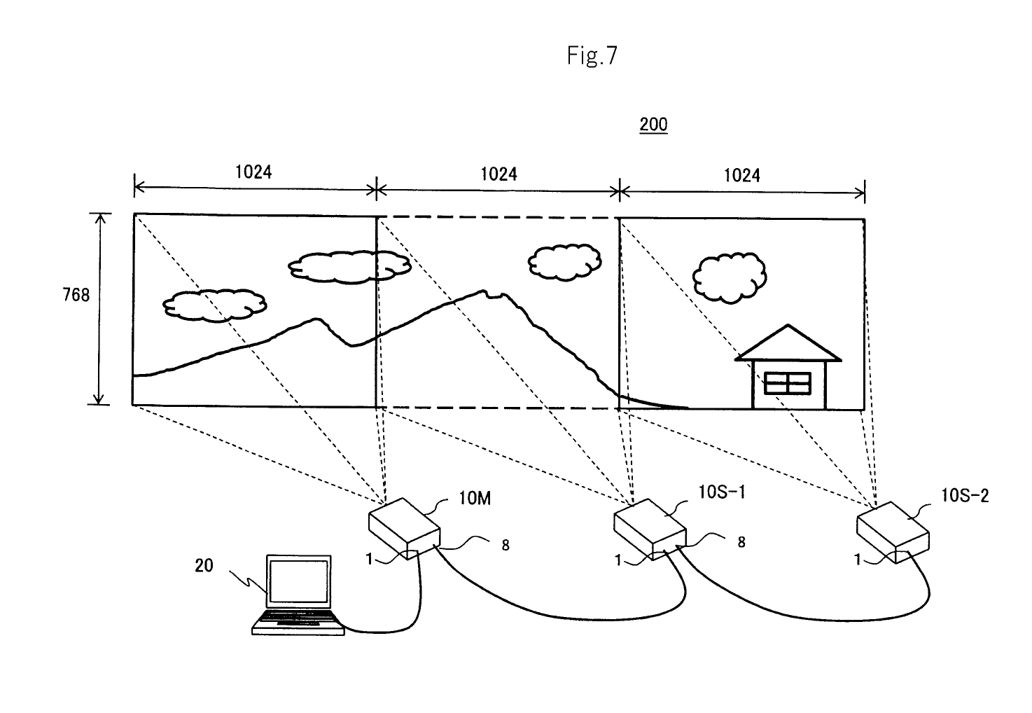

FIG. 6 is a sequence diagram for illustrating an operation example of multi-display system 100.

Control unit 9 of master projector 10M checks whether there is a device connected to output terminal 8 (Step S100). Specifically, control unit 9 of master projector 10M checks whether there is any device connected to input terminal 1 and output terminal 8 by using the hot-plug function of input terminal 1 and output terminal 8. When the user connects output terminal 8 of master projector 10M to input terminal 1 of slave projector 10S by HDMI cable, control unit 9 of master projector 10M detects slave projector 10S as a connected device.

Then, control unit 9 of master projector 10M detects that master projector 10M is the topmost display device of multi-display system 100 from the fact that a device that is connected to output terminal 8 is present whereas there is no device that is connected to input terminal 1. Control unit 9 of master projector 10M acquires the EDID from EDID memory 2 of slave projector 10S connected to output terminal 8 and registers the individual resolution described in the acquired EDID as the second resolution (Step 105).

Control unit 9 of master projector 10M acquires the individual resolution described in the EDID stored in EDID memory 2 of master projector 10M and registers the individual resolution as the first resolution, and compares the first resolution with the second resolution acquired at Step S105 to determine whether the individual resolution of master projector 10M and that of slave projector 10S are the same (Step S110). When the individual resolution of master projector 10M and that of slave projector 10S are not the same, master projector 10M ends the operation of the multi-display system.

On the other hand, when the individual resolution of master projector 10M and that of slave projector 10S are the same, control unit 9 of master projector 10M calculates the system resolution that is the resolution of the synthesized image in which the image displayed by display unit 5 of master projector 10M and the image displayed by display unit 5 of slave projector 10S are joined together. Specifically, control unit 9 of master projector 10M calculates the system resolution based on the resolutions of individual images displayed by different projectors included in multi-display system 100 and based on the allocation of each image in the synthesized image. In the present exemplary embodiment, since it is assumed that two images displayed by projectors 10 are joined horizontally, control unit 9 calculates the system resolution so that the horizontal resolution of the system resolution is twice the horizontal resolution of master projector 10M and the vertical resolution of the system resolution is equal to the vertical resolution of master projector 10M (Step S115).

Then, display unit 5 of master projector 10M displays that the system resolution is selectable. Specifically, display unit 5 of master projector 10M displays resolution options that include, for example, the individual resolution of master projector 10M and the system resolution. At this stage, display unit 5 can display resolution options by using OSD (On Screen Display) or the like (Step S120).

Herein, when the user enters, as a selected resolution, the system resolution on master projector 10M (Step S125), control unit 9 of master projector 10M rewrites the resolution of the EDID stored in EDID memory 2 with the system resolution (Step S130).

Then, when the user connects PC 20 and master projector 10M by HDMI cable, PC 20 acquires the EDID from master projector 10M (Step S135). PC 20 outputs the video signal, that corresponds to the system resolution described in the acquired EDID, and the control signal to master projector 10M (Step S140).

Master projector 10M, upon receiving the video signal and control signal, processes the ED signal included in the control signal. At this time, DE processing unit 12 processes the DE signal so that the part of the video signal, that is displayed by master projector 10M, forms an invalid period (so that the part of the video signal, that is displayed by slave projector 105, forms a valid period) (Step S145).

Then, display unit 5 of master projector 10M, in accordance with the DE signal that is received by receiving unit 3, displays the left half of the image according to the video signal (Step S150).

Output terminal 8 of master projector 10M outputs the video signal and the control signal that includes the processed DE signal to slave projector 10S (Step S155).

Display unit 5 of slave projector 105, which has received the video signal and control signal, displays the right half of the image according to the video signal in accordance with the DE signal included in the received control signal (Step S170).

As described above, according to the present exemplary embodiment, the display device provides notification to the superordinate device of the third resolution according to the first and second resolutions, the first resolution being the resolution of display unit 5, the second resolution being the resolution notified by the subordinate device. As a result, since the superordinate device can recognize the resolution of the subordinate display devices connected to the superordinate device, the signal source, which is the superordinate device, is able to output the video signal whose resolution accords with the notified third resolution. Accordingly, even when a general-purpose signal source such as a PC is used, the signal source can output the video signal with a resolution corresponding to the system configuration, hence the display device can display an image whose resolution corresponds to the system configuration.

Further, according to the present exemplary embodiment, when the first resolution and the second resolution are the same, the third resolution is notified to the superordinate device. When parts of a rectangular image are displayed by a plurality of display devices to form a large image by joining together the individual images that are displayed, there are cases where the images displayed by individual display devices cannot be joined to form an integrated image of a rectangular shape if a plurality of display devices that have different vertical resolutions are put together in the horizontal direction or if a plurality of display devices that have different horizontal resolutions are put together in the vertical direction. In this way, even if the images that are displayed by individual display devices are joined together, this does not mean that the display devices will operate correctly. Accordingly, when modification of the resolution to be notified is limited to the case where the first and second resolutions are the same, it is possible to secure a normal operation of display unit 5.

Moreover, according to the present exemplary embodiment, the third resolution is notified to the superordinate device by replacing the first resolution stored in EDID memory 2 with the third resolution. As a result, it is possible for the superordinate device to output the video signal conforming to the third resolution without making any additional modification to the reading operation of the resolution on the superordinate device side.

According to the present exemplary embodiment, the display device acquires the resolution of the subordinate display device, which is the second resolution, from the EDID of the subordinate display device. The display device processes the ED signal that represents the area to be displayed in the video signal into the information that corresponds to the area that is displayed by the subordinate display device. As a result, the subordinate display device can display the image that corresponds to the third resolution without making any additional modification to the operation on the superordinate device side.

According to the present exemplary embodiment, in master projector 10M to which PC 20 which is the superordinate device and slave projector 10S which is the subordinate display device are connected, the resolution of the synthesized image, in which the images that are displayed by display unit 5 and slave projector 10S are joined together, is calculated based on the first resolution and the second resolution, and the calculated resolution is notified to PC 20, which is the superordinate device, as the third resolution. As a result, master projector 10M can notify the resolution of the synthesized image to PC 20 which is the signal source.

### The Second Exemplary Embodiment

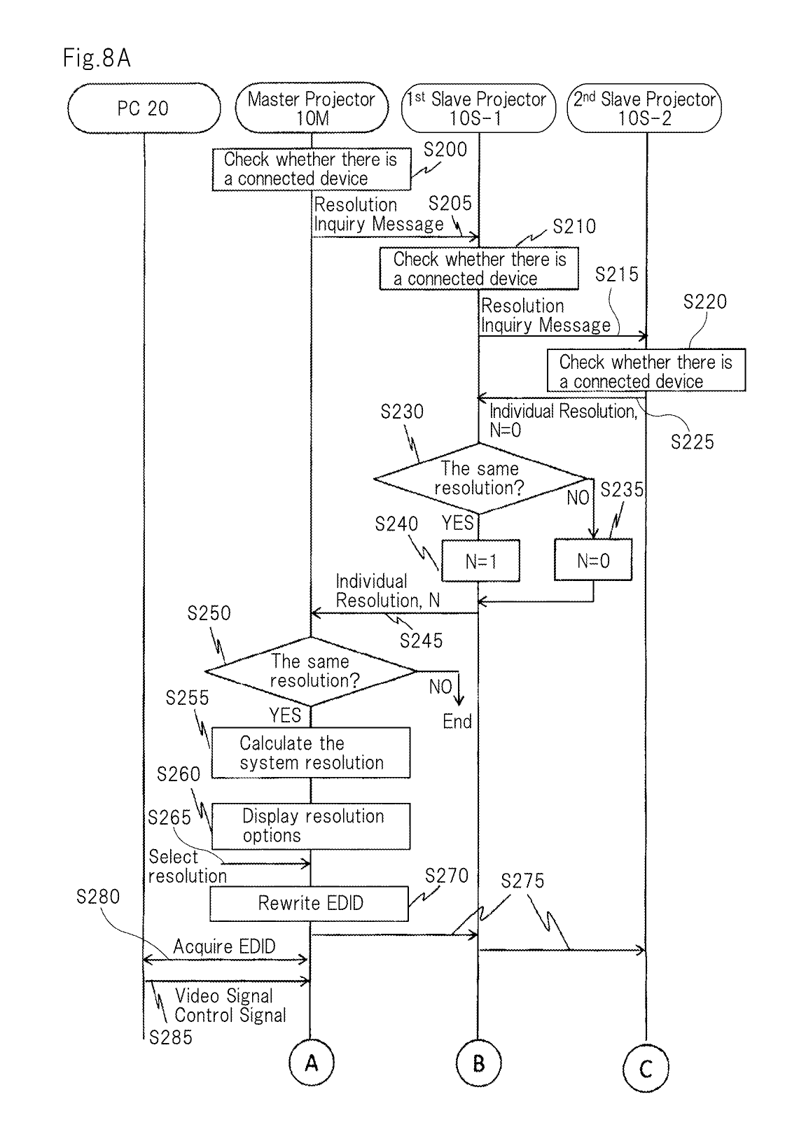

FIG. 7 is a diagram showing a configuration of a multi-display system according to the second exemplary embodiment of the present invention.

Multi-display system 200 according to the second exemplary embodiment of the present invention includes a plurality of projectors 10 and PC 20 that is a signal source of video signals. Of the plural projectors 10, the projector 10 that is directly connected to PC 20 is called master projector 10M. The projector 10 that is not directly connected to PC 20 is called slave projectors 105. In the present exemplary embodiment, multi-display system 200 includes two slave projectors 10S, and master projector 10M is arranged on the leftmost side of the three projectors 10. Of the two slave projectors 105, the projector 10S that is directly connected to master projector 10M and arranged on the left side (at the middle of the three), when viewed toward the image projected by the projectors, is called first slave projector 105-1. The projector 10S that is connected to slave projector 105-1 and arranged on the rightmost side, when viewed toward the image projected by the projectors, is called second slave projector 10S-2.

Input terminal 1 of master projector 10M is connected to PC 20 while output terminal 8 of master projector 10M is connected to input terminal 1 of first slave projector 10S-1. Output terminal 8 of first slave projector 10S-1 is connected to input terminal 1 of second slave projector 10S-2.

Each projector 10 displays an image having a resolution of 1024×768. In this case, multi-display system 200 as a whole displays an image having a resolution of 3072×768.

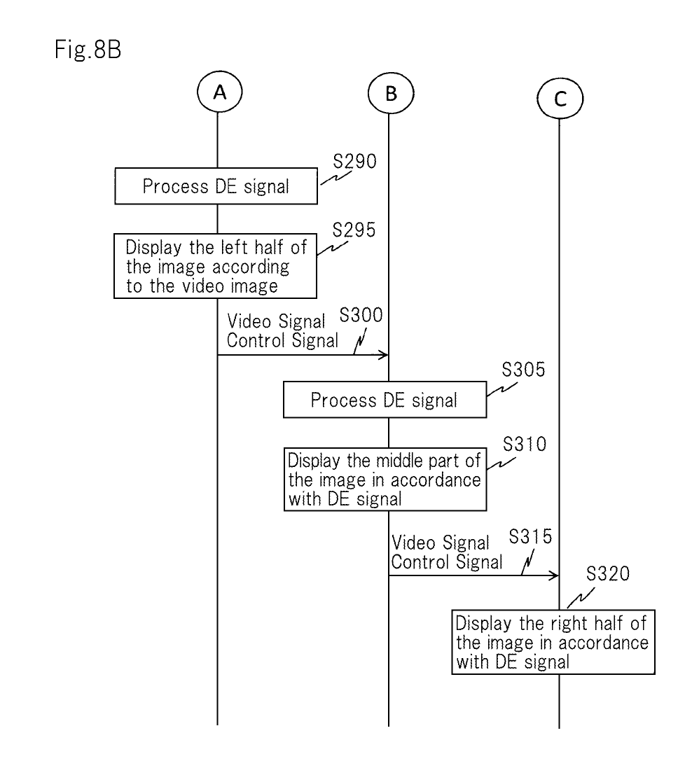

FIGS. 8A and 8B are sequence diagrams for illustrating an operation example of multi-display system 200.

Referring first to FIG. 8A, control unit 9 of master projector 10M checks whether there is any device connected to input terminal 1 and output terminal 8 by using the hot-plug function of input terminal 1 and output terminal 8 (Step S200). When the user connects master projector 10M to first slave projector 105-1 by HDMI cable and connects first slave projector 105-1 to second slave projector 10S-2 by HDMI cable, control unit 9 of master projector 10M detects first slave projector 105-1 that is connected to output terminal 8 as a connected device.

When control unit 9 of master projector 10M detects its connection to first slave projector 105-1, control unit 9 recognizes that master projector 10M is the topmost display device of multi-display system 200 from the fact that a device that is connected to output terminal 8 is present whereas there is no device that is connected to input terminal 1. Then, control unit 9 creates a resolution inquiry message, and outputs the created resolution inquiry message from output terminal 8 to first slave projector 105-1 (Step S205).

Receiving unit 3 of first slave projector 10S-1, which has received the resolution inquiry message, acquires the individual resolution from EDID memory 2. Receiving unit 3 also notifies control unit 9 that a resolution inquiry message has been received. Control unit 9 of first slave projector 105-1 which has received this message checks whether there is any device that is connected to output terminal 8 of first slave projector 105-1 by using the hot-plug function of output terminal 8 (Step S210).

In the present exemplary embodiment, since output terminal 8 of first slave projector 105-1 is connected to second slave projector 10S-2 which is a subordinate display device, control unit 9 of first slave projector 105-1 further outputs a resolution inquiry message to second slave projector 10S-2 (Step S215).

Receiving unit 3 of second slave projector 10S-2, which has received the resolution inquiry message, acquires the individual resolution from EDID memory 2. Receiving unit 3 also notifies control unit 9 that a resolution inquiry message has been received. Control unit 9 of second slave projector 10S-2, which has received this message, checks whether there is any device connected to output terminal 8 of second slave projector 10S-2 by using the hot-plug function of output terminal 8 (Step S220).

Then, control unit 9 of second slave projector 10S-2 detects the number of subordinate display devices connected downstream thereof, i.e., subordinate display device number N, and outputs the information, that indicates the subordinate display device number N, together with the individual resolution of second slave projector 10S-2 to first slave projector 10S-1, which is the superordinate display device, via input terminal 1 (Step S225). In the present exemplary embodiment, since there is no devices that are connected to output terminal 8 of second slave projector 10S-2, control unit 9 of second slave projector 10S-2 outputs information that indicates that the number of devices connected to output terminal 8 of second slave projector 10S-2 is zero. The value of subordinate display device number N may differ depending on the definition regarding whether its own device is included in that number. In the present exemplary embodiment, the subordinate display device number N is set to the number of display devices that are present downstream of the device that generates subordinate display device number N. Accordingly, the display device at the terminal, to which no subordinate device is connected, generates and outputs a subordinate display device number N that indicates zero.

Control unit 9 of first slave projector 10S-1, which has received the subordinate display device number N=0 and the individual resolution from second slave projector 10S-2, detects that first slave projector 10S-1 has only one subordinate display device, from the fact that the received subordinate display device number N is zero. Then, control unit 9 of first slave projector 10S-1 determines whether the individual resolution that is notified from second slave projector 10S-2 is the same as the individual resolution of first slave projector 10S-1 (Step S230).

When the individual resolution of first slave projector 10S-1 is not the same as the individual resolution of second slave projector 10S-2, control unit 9 of first slave projector 10S-1 sets subordinate display device number N to be zero (N=0) (Step S235).

On the other hand, when the individual resolution of first slave projector 105-1 is the same as the individual resolution of second slave projector 10S-2, control unit 9 of first slave projector 105-1 adds 1 to the received subordinate display device number N so that N=1 (Step S240). Then, control unit 9 of first slave projector 105-1 notifies this subordinate display device number N and the individual resolution of first slave projector 105-1 to master projector 10M which is the superordinate device (Step S245).

Then, control unit 9 of master projector 10M determines whether the individual resolution of master projector 10M and the individual resolution of first slave projector 105-1 are the same (Step S250). When the individual resolution of master projector 10M is not the same as the individual resolution of first slave projector 105-1, control unit 9 of master projector 10M ends the operation of the multi-display system.

On the other hand, when the individual resolution of master projector 10M is the same as the individual resolution of first slave projector 10S-1, control unit 9 of master projector 10M calculates the system resolution that is the resolution of the synthesized image in which the images displayed by display unit 5 of each of master projector 10M, first slave projector 105-1 and second slave projector 10S-2 are joined together.

Specifically, control unit 9 detects, based on the number of the subordinate display devices that is notified by first slave projector 105-1, the number of slave projectors 10S that are connected via output terminal 8 of master projector 10M. Based on the detected number of slave projectors 105, the individual resolution of master projector 10M, the individual resolution of first slave projector 105-1 and the individual resolution of second slave projector 10S-2, control unit 9 calculates the system resolution that is the resolution of the synthesized image in which the images displayed by display unit 5 of each of master projector 10M, first slave projector 105-1 and second slave projector 10S-2 are joined together.

In the present exemplary embodiment, since it is assumed that plural projectors 10 are cascade connected in the horizontal direction and that the number of slave projectors 10S are two, control unit 9 calculates the system resolution to have three times the horizontal resolution of master projector 10M and the same vertical resolution as that of master projector 10M (Step S255).

Here, the system resolution is not limited to the resolution that corresponds to all of the number of the detected slave projectors 10S, but may use the resolution calculated based on a number equal to or lower than the number of the detected slave projectors 10S. In the present exemplary embodiment, both the system resolution to have two times the horizontal resolution of master projector 10M and the system resolution to have three times the horizontal resolution of master projector 10M may be calculated.

Then, display unit 5 of master projector 10M displays that the system resolution is selectable. Specifically, display unit 5 displays resolution options including, for example, the individual resolution of master projector 10M and the calculated system resolutions. At this time, master projector 10M can display resolution options by using OSD or the like (Step S260).

Herein, when the user selects and enters, as a selected resolution, a system resolution from the displayed resolution options on master projector 10M (Step S265), control unit 9 of master projector 10M replaces the resolution of the EDID stored in EDID memory 2 with the system resolution (Step S270).

When the system resolution is selected as the selected resolution, control unit 9 of master projector 10M transmits, to first slave projector 10S-1, information that indicates that multi-display is selected. This information that indicates that multi-display is selected is notified downstream to at least the slave projector 10S that corresponds to the selected system resolution. Here, the information that indicates that multi-display is selected includes information that instructs processing of DE signals (Step S275).

Then, when the user connects PC 20 to master projector 10M by HDMI cable, PC 20 acquires the EDID of master projector 10M (Step S280). PC 20 outputs the video signal, that corresponds to the system resolution described in the acquired EDID, and the control signal to master projector 10M (Step S285).

Referring next to FIG. 8B, master projector 10M, upon receiving the video signal and control signal, processes the ED signal included in the control signal. Herein, video signal processing unit 4 of master projector 10M processes the DE signal so that the area in the video signal, that is to be displayed by master projector 10M, forms a valid period. On the other hand, DE processing unit 12 processes the DE signal so that the area in the video signal, that is to be displayed by master projector 10M, forms an invalid period (Step S290). Here, the area that is to be displayed by master projector 10M is a section, with respect to the horizontal direction, from the start of the valid period of the DE signal supplied to master projector 10M to the end of the width of the resolution of the display unit.

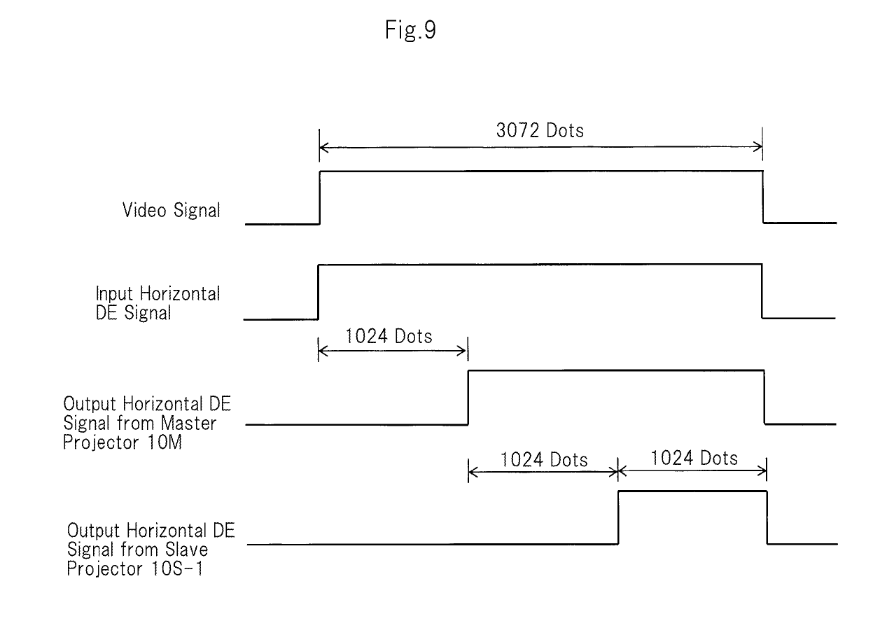

FIG. 9 is a diagram for illustrating the processing of the horizontal DE signal. In the present exemplary embodiment, a video signal having a resolution of 3072×768 is supplied. The input horizontal DE signal, which is the horizontal DE signal input to DE processing unit 12 of master projector 10M, indicates that the entire period provided by 3072 dots of the video signal in the horizontal direction is the valid period. DE processing unit 12 of master projector 10M processes the input horizontal DE signal so that the period of the first 1042 dots of the video signal indicates an invalid period.

Returning to the explanation of FIG. 8B, display unit 5 of master projector 10M, in accordance with the DE signal processed by video signal processing unit 4, displays the image according to the video signal (part from the first dot to 1024^{th} dots or the 1024 dots on the left side) (Step S295). Master projector 10M outputs the video signal and the control signal that includes the DE signal processed by DE processing unit 12 to first slave projector 105-1 (Step S300).

First slave projector 105-1, upon receiving the video signal and the control signal, processes the DE signal included in the control signal. Video signal processing unit 4 of first slave projector 105-1 processes the DE signal so that the area in the video signal, that is to be displayed by first slave projector 105-1, is set to a valid period. On the other hand, DE processing unit 12 of first slave projector 105-1 processes the DE signal so that the area in the video signal, that is to be displayed by slave projector 105-1, is set to an invalid period. Here, the area that is to be displayed by first slave projector 105-1 is a section, with respect to the horizontal direction, from the start of the valid period of the DE signal supplied to slave projector 105-1 to the end of the width of the resolution of the display unit.

Returning again to FIG. 9, DE processing unit 12 of first slave projector 10S-1 processes the horizontal DE signal output from master projector 10M so that the period of the middle 1042 dots of the video signal is set to an invalid period (Step S305).

Returning again to the explanation of FIG. 8B, display unit 5 of first slave projector 10S-1, in accordance with the DE signal processed by video signal processing unit 4, displays the image according to the video signal. Thereby, display unit 5 of first slave projector 10S-1 displays the image according to the video signal from the start of the valid period indicated by the DE signal to the end of the width of the horizontal resolution of display unit 5 (Step S310).

First slave projector 10S-1 outputs the video signal and the control signal that includes the DE signal processed by DE processing unit 12 of first slave projector 10S-1 to second slave projector 10S-2 (Step S315).

Upon receiving the video signal and the control signal, second slave projector 10S-2 does not need to process the DE signal included in the control signal because second slave projector 10S-2 is the device at the distal end. Here, the area that is to be displayed by second slave projector 10S-2 is a section, with respect to the horizontal direction, from the start of the valid period of the DE signal input to second slave projector 10S-2 to the end of the width of the resolution of the display unit.

Display unit 5 of second slave projector 10S-2, in accordance with the DE signal that is included in the received control signal, displays the image according to the video signal. Thereby, display unit 5 of second slave projector 10S-2 displays the image (the part from 2049^{th} to 3072^{nd} dots, 1024 dots on the right side) that conforms to the video signal from the start of the valid period indicated by the DE signal to the end of the width of the horizontal resolution of display unit 5 (Step S320).

Here, in multi-display system 200, for master projector 10M, PC 20 is the superordinate device while first slave projector 10S-1 and second slave projector 10S-2 are the subordinate display devices. The individual resolution of master projector 10M corresponds to the first resolution, the individual resolution of slave projector 10S corresponds to the second resolution and the system resolution corresponds to the third resolution.

For first slave projector 10S-1, master projector 10M is the superordinate device while second slave projector 10S-2 is the subordinate display device. The individual resolution of first slave projector 10S-1 corresponds to the first resolution, the individual resolution of second slave projector 10S-2 corresponds to the second resolution and the individual resolution of first slave projector 10S-1 and second slave projector 10S-2 correspond to the third resolution.

In the description herein, first slave projector 10S-1 checks whether the individual resolution of first slave projector 10S-1 is the same as the individual resolution of second slave projector 10S-2, and notifies the number of the subordinate display devices and the individual resolution of first slave projector 10S-1 to master projector 10M when the resolutions are the same. However, first slave projector 10S-1 may report the individual resolution of both first slave projector 10S-1 and second slave projector 10S-2 to master projector 10M. In this case, master projector 10M can check whether the individual resolution of master projector 10M, first slave projector 10S-1 and second slave projector 10S-2 are all the same to perform the operation of master projector 10M.

As has been described above, according to the present exemplary embodiment, the display device provides notification to the superordinate device of the third resolution according to the first and second resolutions, the first resolution being the resolution of display unit 5, the second resolution being the resolution notified by the subordinate device. As a result, since the superordinate device can recognize the resolution of the subordinate display devices connected to the superordinate device, the signal source, which is the superordinate device, is able to output the video signal whose resolution accords with the notified third resolution. Accordingly, even when a general-purpose signal source such as a PC is used, the signal source can output the video signal with a resolution corresponding to the system configuration, hence the display device can display an image whose resolution corresponds to the system configuration.

Also in this present exemplary embodiment, when the first resolution and the second resolution are the same, the third resolution is notified to the superordinate device. When parts of a rectangular image are displayed by a plurality of display devices to form a large image by joining together the individual images that are displayed, there are cases where the images displayed by individual display devices cannot be joined to form an integrated image of a rectangular shape if a plurality of display devices that have different vertical resolutions are put together in the horizontal direction or if a plurality of display devices that have different horizontal resolutions are put together in the vertical direction. In this way, even if the images that are displayed by individual display devices are joined together, this does not mean that the display devices will operate correctly. Accordingly, when modification of the resolution to be notified is limited to the case where the first and second resolutions are the same, it is possible to secure a normal operation of display unit 5.

Moreover, according to the present exemplary embodiment, the third resolution is notified to the superordinate device by replacing the first resolution stored in EDID memory 2 with the third resolution. As a result, it is possible for the superordinate device to output the video signal conforming to the third resolution without making any additional modification to the reading operation of the resolution on the superordinate device side.

According to the present exemplary embodiment, the display device acquires the resolution of the subordinate display device, which is the second resolution, from the EDID of the subordinate display device. The display device processes the ED signal that represents the area to be displayed in the video signal into the information that corresponds to the area that is displayed by the subordinate display device.

According to the present exemplary embodiment, in master projector 10M to which PC 20 which is the superordinate device and slave projector 10S which is the subordinate display device are connected, the resolution of the synthesized image, in which the images that are displayed by display unit 5 and slave projector 10S are joined together, is calculated based on the first resolution and the second resolution, and the calculated resolution is notified to PC 20, which is the superordinate device, as the third resolution. As a result, master projector 10M can notify the resolution of the synthesized image to PC 20 which is the signal source.

As has been described, in the second exemplary embodiment, slave projector 10S which is a subordinate display device notifies the individual resolution to the superordinate device. However, the present invention should not be limited to this example. For example, slave projector 10S may notify the resolution of the image combined of the images displayed by slave projectors 10S including itself and subordinate projectors, to the superordinate device. At this time, slave projector 10S replaces the resolution described in the EDID with the resolution to be notified.

Further, in the above exemplary embodiment, slave projector 10S which is a subordinate display device transmits the number of subordinate devices to the superordinate device. However, the present invention should not be limited to this example. For example, the number of subordinate devices may be written into the EDID so as to be notified to the superordinate device. For example, the number of subordinate devices may be described and rewritten in the area of the EDID that indicates the device name (Monitor Name), together with the device name in a manner such that the number of subordinate devices can be differentiated from the device name. Alternatively, the number of subordinate devices may be described in the other area that does not affect the operation in which the EDID is used.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

For example, the above exemplary embodiment has been described by taking projector 10 as an example of the display device. But the present invention should not be limited to this example. The display device may be a display device that includes a display panel such as a liquid crystal display device, organic EL (Electro Luminescence) display device and the like. Further, the display device may be an information processing apparatus that includes a projector or a display panel.

Further, the above exemplary embodiment has been described by taking PC 20 as one example of the signal source for supplying the video signal to projector 10, but the present invention should not be limited to this example. The signal source may be an information processing apparatus other than PC 20. The display device and the signal source may be an integrated apparatus.

The above exemplary embodiment has been described on the assumption that projectors 10 as well as PC 20 and master projector 10M are connected by terminals and cables that support the HDMI standard. However, the present invention should not be limited to this example. Devices may be connected by using wired or wireless connection means and any standard that supports terminals, cables and wireless interface may be used.

For description simplicity, the above exemplary embodiments have been described by giving cases where two projectors 10 are used and where three are used. However, the present invention should not be limited to these examples. It is possible to configure a multi-display system with four or more projectors.

The above exemplary embodiments have been described by giving an example of a multi-display system in which the images that are displayed by the projectors are joined together in the horizontal direction. However, the present invention should not be limited to this example. For example, the images that are displayed by the projectors may be joined together in the vertical direction. In this case, instead of the horizontal DE signal, the vertical DE signal is processed.

The above exemplary embodiments have been described by giving an example where the image according to the video signal is divided into multiple areas that do not overlap and the display devices each displays each area. However, the present invention should not be limited to this example. When the display devices are projectors, there is a case where part of the projected image of each projector is laid over the others so that the multiple projected images produce smooth seams. In this case, each projector may and should take into account the overlapping portions to calculate the system resolution and process the DE signal.

Further, in the above exemplary embodiments, a process of setting up a multi-display system is performed when the individual resolutions are the same. However, in the case in which the images are arranged in the horizontal direction, the multi-display system may be set up when the vertical resolutions are the same, and furthermore, in the case in which the images are arranged in the vertical direction, the multi-display system may be set up when the horizontal resolutions are the same for arranging the images in the vertical direction. In this case, the second resolution to be notified by the subordinate display device to the superordinate device should be the resolution of the combined image of the images displayed by the display devices connected downstream of the notifying device. In this case, the combined synthesized image of the images displayed by individual display devices forms a rectangular shape so that the synthesized image can be displayed normally.

In the above exemplary embodiment, control unit 9 uses hot-plug function to recognize that projector 10 is the topmost display device (master projector 10M) of multi-display system 200. However, control unit 9 may set a projector 10 as the topmost display device (master projector 10M) of multi-display system 200, based on a signal that indicates a predetermined operation performed by the user, for example, an operation for setting up the projector 10 to be master projector 10M. Further, in this case, if master projector 10M is set as the topmost display device of multi-display system 200, control unit 9 of master projector 10M may check whether there is a device connected to output terminal 8, and then if control unit 9 detects slave projector 10S that is connected to output terminal 8, control unit 9 may issue a resolution inquiry message to perform a predetermined process. Alternatively, control unit 9 of master projector 10M may check whether there is a device connected to output terminal 8 based on a signal that represents a predetermined operation performed by the user, for example, a signal that represents an operation of setting up a system resolution, and then if control unit 9 detects slave projector 10S that is connected to output terminal 8, control unit 9 may issue a resolution inquiry message to perform a predetermined process.

Also, it goes without saying that the configurations and processing content in each of the above exemplary embodiments can be used in combination.

For example, the first exemplary embodiment gave an example of two projectors 10 while the second exemplary embodiment gave an example of three projectors 10. However, the present invention should not be limited to these examples. The process of the second exemplary embodiment may be applied to a multi-display system using two projectors.

In the first exemplary embodiment, video signal processing unit 4 does not process the DE signal while display unit 5 displays the image from the start of the DE signal according to the resolution of display unit 5. In the second exemplary embodiment, video signal processing unit 4 processes the DE signal in accordance with the resolution of display unit 5 while display unit 5 displays the image according to the processed DE signal. The above process of the second exemplary embodiment may be applied to the first embodiment, and also the above process of the first exemplary embodiment may be applied to the second embodiment.

In the first exemplary embodiment, the superordinate device directly acquires EDID. In the second exemplary embodiment, EDID is acquired by way of receiving unit 3 of the subordinate display device. The direct EDID acquisition process by the superordinate device may be performed in the configuration of the second exemplary embodiment. Also, the process of acquiring EDID via receiving unit 3 of the subordinate display device may be performed in the configuration of the first exemplary embodiment.

In the first exemplary embodiment, the superordinate device acquires the EDID itself of the subordinate display device. In the second exemplary embodiment, the superordinate device acquires the individual resolution described in the EDID of the subordinate display device. The process of acquiring the EDID itself may be performed in the configuration of the second exemplary embodiment. Also, the process of acquiring the individual resolution may be performed in the configuration of the first exemplary embodiment.

In the above exemplary embodiments, although the resolution in the EDID is acquired and used, the present invention should not be limited to this example. A resolution that is included in the information other than EDID, that indicates the performance and functions of display unit 5 or the like that are stored in the storage unit, may be acquired and used.

The first exemplary embodiment was explained by showing an operation on the assumption that multi-display system 100 includes two projectors 10. The second exemplary embodiment was explained by showing an operation in which multi-display system 100 detects the current system configuration. In the configuration of the first exemplary embodiment, an operation of detecting the current system configuration may be carried out. Also, in the configuration of the second exemplary embodiment, a predetermined system configuration may be assumed. When a predetermined system configuration may be assumed, it is possible to consider a case where a predetermined system configuration has been fixed as the specifications of projectors 10, or a case where the user enters the number of projectors 10 to be connected at the time of configuring a system.

### DESCRIPTION OF REFERENCE NUMERALS

100, 200 multi-display system
10 projector
10M master projector
10S slave projector
1 input terminal
2 EDID memory (storage unit)
3 receiving unit
4 video signal processing unit
5 display unit
6 drive unit
7 output unit
8 output terminal
9 control unit
11 format converter
12 ED processing unit (processing unit)
13 transmitting unit

1. A display device comprising:
a receiving unit that receives a video signal output from a superordinate device;
a display unit that displays at least a part of an image according to the video signal;
a storage unit that stores a resolution of the image to be displayed on the display unit;
a connector to which a subordinate display device can be connected;
a communication unit that, when a subordinate display is connected to the connector, receives a second resolution, which is a resolution notified by the subordinate display device, and outputs the video signal to the subordinate display device; and,
a control unit that provides notification to the superordinate device of a third resolution according to a first resolution and the second resolution, wherein the first resolution is a resolution of the display unit and is a resolution of an image that is displayed on the display unit, the resolution of the image being previously stored in the storage unit.

2. The display device according to claim 1, wherein when a subordinate display device is connected to the connector,
the superordinate device comprises another display device, and
the control unit detects the number of subordinate display devices when the first resolution and the second resolution are the same, and sets the first resolution as the third resolution and notifies the third resolution and the number of subordinate display devices to the superordinate device.

3. The display device according to claim 2, wherein the communication unit receives the resolution of the subordinate display device as the second resolution from the subordinate display device.

4. The display device according to claim 1, wherein when a subordinate display device is connected to the connector,
the superordinate device comprises a signal source that outputs the video signal,
the control unit calculates, based on the first resolution and the second resolution, a resolution of a synthesized image in which the image displayed by the display unit and the image displayed by the subordinate display device are joined together, and notifies the calculated resolution as the third resolution to the superordinate device.

5. The display device according to claim 1, wherein the control unit replaces the first resolution stored in the storage unit with the third resolution to thereby notify the third resolution to the superordinate device.

6. The display device according to claim 1, wherein
the receiving unit receives, from the superordinate device, display area information that indicates an area to be displayed in the image according to the video signal,
the display unit displays the image according to the video signal in accordance with the display area information that is received by the receiving unit, and
the communication unit processes the display area information into information that corresponds to an area to be displayed by the subordinate display device and outputs the processed information to the subordinate display device.

7. A multi-display system comprising:
a signal source that outputs a video signal; and
a plurality of display devices that each displays part of an image according to the video image output from the signal source, wherein
the plural display devices are cascade connected, and
each display device includes:
a receiving unit that receives a video signal output from a superordinate device;
a display unit that displays at least part of the image according to the video signal;
a storage unit that stores a resolution of an image to be displayed on the display unit;
a connector to which a subordinate display device can be connected;
a communication unit that, when a subordinate display is connected to the connector, receives a second resolution, that is a resolution notified by the subordinate display device, and outputs the video signal to the subordinate display device; and,
a control unit that provides notification to the superordinate device of a third resolution according to a first resolution and the second resolution, wherein the first resolution is a resolution of the display unit and is a resolution of an image that is displayed on the display unit, the resolution of the image being previously stored in the storage unit.

8. A multi-display method for a multi-display system that includes a signal source that outputs a video signal; and a plurality of display devices that each displays part of an image according to the video image output from the signal source, the plural display devices being cascade connected, the multi-display method comprising,
each display device:
detecting that a subordinate display device is connected to the display device;
acquiring, from a storage unit, a first resolution which is a resolution of the display unit and which is a resolution of an image that is displayed on the display unit;
receiving a second resolution which is a resolution notified by the subordinate display device;
providing notification to the superordinate device of a third resolution according to the first and second resolutions;
receiving a video signal according to the third resolution from the superordinate device;
displaying part of the received video signal; and,
outputting the video signal to the subordinate device.
